(19) United States
(12) Patent Application Publication
(10) Pub. No.: US 2003/0154487 A1
(43) Pub. Date: Aug. 14, 2003

(54) Digital content providing system

(75) Inventor: Jiro Tsumura, Kyoto (JP)

Correspondence Address: MCDERMOTT, WILL & EMERY, 600 13th Street, N.W., WASHINGTON, DC, 20005-3096, US

(73) Assignee: Dainippon Screen Mfg. Co., Ltd.

(21) Appl. No.: 10/359,083

(22) Filed: Feb. 6, 2003

(30) Foreign Application Priority Data
Feb. 6, 2002 (JP) P2002-29212
Mar. 15, 2002 (JP) P2002-71451
Nov. 21, 2002 (JP) P2002-337653

(51) Int. Cl. H04N 7/173; H04N 7/16; G06F 15/16

(52) U.S. Cl. 725/93; 709/217; 725/116; 725/146

(57) ABSTRACT

A condition for executing an event relating to a delivery management is set in accordance with delivery objects (content, publicity information) and if the event execution condition is satisfied as the result of repeating delivery of the delivery objects to a user, the event is executed. A manager of a server can provide information that a provider of the delivery objects needs without continuous monitoring of a delivery of the delivery objects. To a content, publicity information relating to the details thereof is linked. Further, on the basis of points which are given at every use of the content and every view of the publicity information, a content fee is discounted by the amount corresponding to the views of the publicity information. Since the publicity information that the user views is not an advertisement irrelevant to the details of the content and the content fee is discounted, it is possible to produce an effective advertisement which causes few complaints of the user. Thus provided is a content providing system which reduces the load of monitoring on a delivery status of the delivery objects, maintains the level of satisfaction of the user and achieves a delivery method with highly effective advertisement.

### BACKGROUND OF THE INVENTION

1. Field of the Invention

The present invention relates to a technique to perform delivery and billing in a digital content providing system through a network.

2. Description of the Background Art

With the prevalence of high-speed lines, various services using the internet have come into use. Among typical internet services using the high-speed lines are, for example, provision of application software which is set on a server by an ASP (Application Service Provider) to allow the users to use the application software through the internet and a moving picture delivery which is a deliver of digital contents (hereinafter, referred to simply as contents), such as movies and video clips, to the users on demand from the server.

For use of such services, the users usually have to pay a fee for the service. As methods of payment, payment with electric money has been realized besides a conventional direct debit from a bank account and payment with a credit card.

Further, a method of providing a content without such direct payments as above has been also realized. Specifically, by delivering publicity information together when the content is provided from the server, a service provider gains a profit from an advertisement fee received from the client that provides the publicity information. This is the same method as the present broadcasting by commercial broadcasters such as television or radio and is easy to gain the understanding of the users, being acceptable without opposition, and the users who view the publicity information delivered together with the services can eliminate the necessity of payment for the services.

Herein, “viewing” the publicity information means not only displaying the publicity information delivered together with the services on the user terminal but presenting detailed publicity information audiovisually by user's click of the display screen, and the like.

Further, “delivery” means streaming that continuously provides the content to the users from the server, download that collectively provides the content to the users, or the like.

In order for the ASP to provide high-quality services to the users, the ASP needs to always receive the provision of the latest content from the content provider. For this, the ASP is required to report the status of users' accesses to the provided content to the content provider and needs to request the content provider to update and add the content as appropriate on the basis of the access status. The real-time operation for reporting the access status and requesting the update and addition of the content, however, is a great burden on a manager of the ASP.

When the content provider updates or adds the content, the ASP further needs to pay the value for the content, and disadvantageously needs much expense in time and effort for giving information to the content provider one after another.

Further, the ASP receives the delivery commission of the publicity information from the publicity information provider to perform a delivery of the publicity information, and the ASP needs management of the delivery of the publicity information so as not to deliver the publicity information over the amount corresponding to the received delivery commission. Unlike the conventional advertisement by the broadcasting, however, the delivery management of the provided publicity information is performed by the ASP on the basis of the number of accesses to the publicity information. When the number of accesses reaches a predetermined number, it is necessary to temporarily stop the delivery of the publicity information and request the publicity information provider to pay the commission for a redelivery of the publicity information. This raises a problem that the manager of the ASP needs to continuously monitor the accesses to the publicity information.

When the publicity information provider pays the commission again, it is necessary to immediately resume the delivery of the publicity information or continue the delivery of the publicity information. Therefore, the manager of the ASP also needs to continuously monitor the communications from the publicity information provider.

On the other hand, when the publicity information is delivered together with the content which is desired by the user, a good effect of the publicity information is not expected since the publicity information that the users do not want is delivered in most cases. Unlike the broadcasting of television or radio, since most of the users who desire the services using the internet make access to the server with a particular purpose, the publicity information irrelevant to the desired services barely arouses their appetites for buying.

Therefore, there is few merit in advertising for the publicity information provider and the delivery of the undesired publicity information is disagreeable to the users.

### SUMMARY OF THE INVENTION

The present invention is intended for a digital content providing system through a network.

According to an aspect of the present invention, the digital content providing system includes a) a server for delivering a digital content through a network; b) at least one terminal for receiving the digital content for a user; c) at least one content providing element which is a provider of at least one digital content for the server; and d) at least one publicity information providing element which is a provider of at least one publicity information for the server. In the digital content providing system, at least one of the at least one publicity information is delivered together when the digital content is delivered from the server. The server includes a-1) an event execution element for executing an event when a predetermined event execution condition corresponding to the event is satisfied; a-2) an event execution condition setting element for setting the event execution condition on the number of deliveries of the digital content or the publicity information; and a-3) a counting element for counting the number of deliveries.

In the present invention, an ASP which provides the digital content can timely execute the events such as a notification of the status of using the content, a new content provision request, a notification of information on a profit which is gained by the delivery and billing of delivery commission to a content provider and a publicity information provider without continuous monitoring of the status of using the content.

According to another aspect of the present invention, the digital content providing system includes a) a server for delivering a digital content through a network; b) at least one terminal for receiving the digital content for a user; c) at least one content providing element which is a provider of at least one digital content for the server; and d) at least one publicity information providing element which is a provider of at least one publicity information for the server. In the digital content providing system, at least one of the at least one publicity information is delivered together when the digital content is delivered from the server. The server includes a-1) a point setting element for setting a content point which is given in accordance with use of the digital content and a publicity information point which is given in accordance with view of the publicity information; and a-2) a point storing element in which the content point which is set is stacked every time when the user uses the digital content and the publicity information point which is set is stacked every time when the user views the publicity information; and a-3) a billing element for calculating a billing amount for use of the digital content, the billing amount being calculated on the basis of the total value of the content point, the total value of the publicity information point and a part amount which is set per one point of the content point.

In this aspect of the present invention, the user of the digital content can use the content at a lower price than a predetermined rate by viewing the relevant publicity information while using the content.

According to this aspect of the present invention, preferably, the server of the digital content providing system further includes a-4) a keyword setting element for setting a content keyword based on details of the digital content and a publicity information keyword based on details of the publicity information; and a-5) a link element for establishing a link between the digital content and the publicity information on the basis of the content keyword and the publicity information keyword.

Since the users view the publicity information relevant to the content, it is possible to expect great effectiveness of advertisement.

Therefore, it is an object of the present invention to provide a digital content providing system for delivering the publicity information together while delivering the digital content, which allows an easy delivery management and produces great effectiveness of advertisement to the users.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a constitution of a content providing system;

FIG. 2 is a view showing constituent elements used mainly for a delivery management process among those constituting a server;

FIG. 3 is a flowchart showing a procedure for a delivery of a content;

FIG. 4 is a flowchart showing a procedure for a delivery of publicity information;

FIG. 5 is a view showing constituent elements used mainly for a billing process among those constituting the server;

FIG. 6 is a flowchart showing a procedure for use of the content;

FIGS. 7A to 7D are views showing constitutions of the content and the publicity information;

FIG. 8 is a flowchart showing an operation of Step S46 in detail;

FIG. 9 is a flowchart showing an operation of Step S47 in detail;

FIG. 10 is a flowchart showing another operation of the content providing system;

FIG. 11 is a flowchart showing another operation of Step S46; and

FIG. 12 is a flowchart showing still another operation of the content providing system.

### DESCRIPTION OF THE PREFERRED EMBODIMENTS

System Constitution for Delivery Status Management

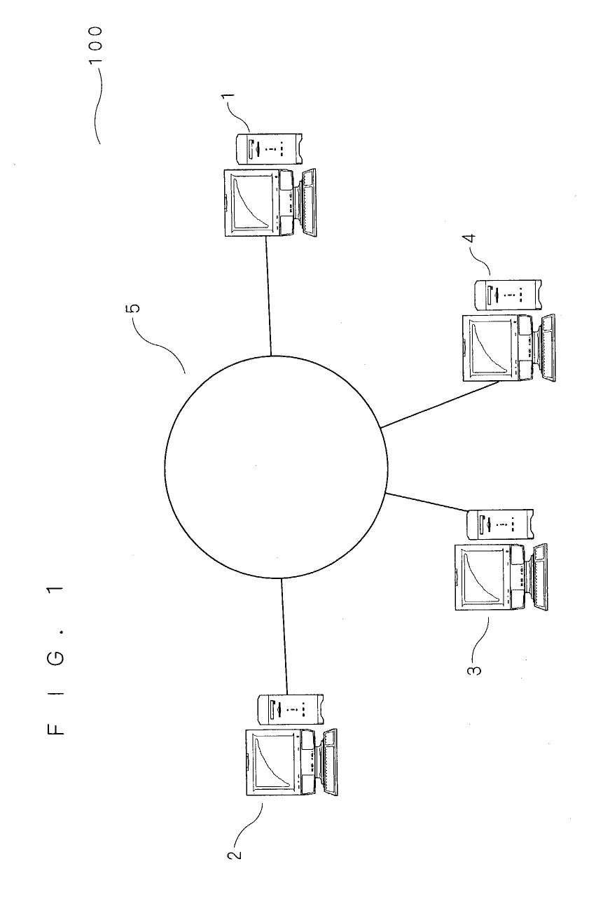

FIG. 1 is a view showing a constitution of a content providing system 100 in accordance with the present invention. First, discussion will be made on a delivery status management on contents and publicity information in the content providing system 100.

The content providing system 100 is constituted of a server 1 that an ASP has, a user terminal 2 that a user of contents has, a content provider terminal 3 that a provider of the contents has, a publicity information provider terminal 4 that a provider of publicity information has and a network 5 which connects these constituent elements.

The content provider terminal 3 is used in order for the content provider to provide a content CT which is digital data for the server 1 of the ASP. The content provider gains part of a profit that the ASP gains through delivering the content CT to the users as a value of providing the content.

The publicity information provider terminal 4 is used in order for the publicity information provider to provide publicity information SJ which is digital data for the server 1 of the ASP. In providing the publicity information SJ, the publicity information provider pays a delivery commission to the ASP and thereby has the ASP deliver the publicity information SJ to the user terminal 2 from the server 1.

The network 5 is a wide area network which allows two-way communication such as the internet and establishes connections between the server 1 and the user terminal 2, between the server 1 and the content provider terminal 3 and between the server 1 and the publicity information provider terminal 4. The content CT and the publicity information SJ are provided to the server 1 from the content provider terminal 3 and the publicity information provider terminal 4 through the network 5.

The user terminal 2 is a device to view the content CT and the publicity information SJ delivered from the server 1. As the user terminal 2, a commonly-used personal computer with a Web browser, such as Internet Explorer (application software of Microsoft, USA) and Netscape Communicator (application software of Netscape, USA), a settop box having a playback facility for the content CT or the publicity information SJ, and the like may be used.

In using desired content CT, the user of the content uses the user terminal 2 to make access to the server 1 through the network 5. At this time, the user can be provided with the publicity information SJ as needed, to view it. The user can use the content CT at a low cost by viewing the publicity information SJ.

The server 1 serves to deliver the content CT and the publicity information SJ provided from the content provider terminal 3 and the publicity information provider terminal 4, respectively, to the user terminal 2.

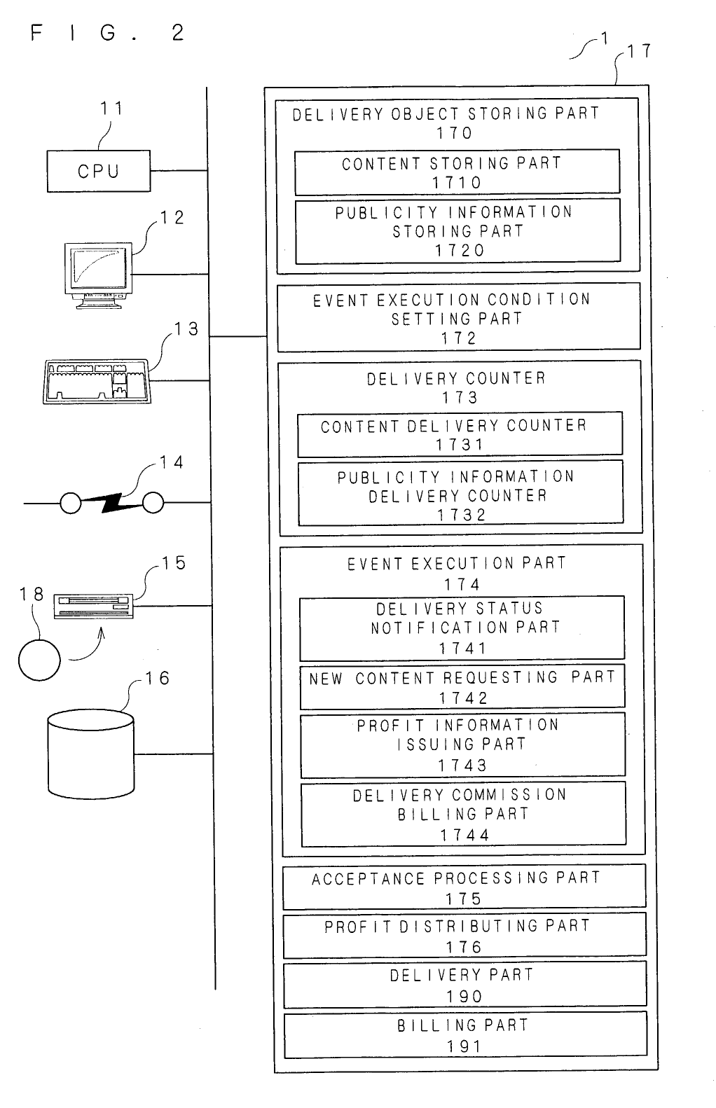

FIG. 2 is a view showing a constitution of the server 1 in accordance with the present invention. The server 1 is a commonly-used personal computer and constituted of a CPU 11, a display part 12, an input part 13, a network I/F 14, a media drive 15, a storage part 16 the a memory 17. The CPU 11 entirely controls the server 1, and particularly executes a program stored in the media disk 18 inserted into the media drive 15, to implement the function of the server 1. The display part 12 is used to display information required for a process of delivering the content CT and the publicity information SJ. The input part 13 includes a mouse or a keyboard and is used when an operator inputs an instruction for the server 1. The network I/F 14 is used to connect the server 1 and the network 5. Through the network I/F 14, the server 1 receives the content CT and the publicity information SJ from the content provider terminal 3 and the publicity information provider terminal 4, respectively, which are connected to the network 5 and provides the content CT and the publicity information SJ to the user terminal 2. Further, by another server which is not shown, it is possible to download a program to implement the function of the server 1. The media drive 15 is used to read the program stored in the media disk 18. With the program read out by the media drive 15, the function of the server 1 is implemented. The storage part 16 stores the program read out by the media drive 15.

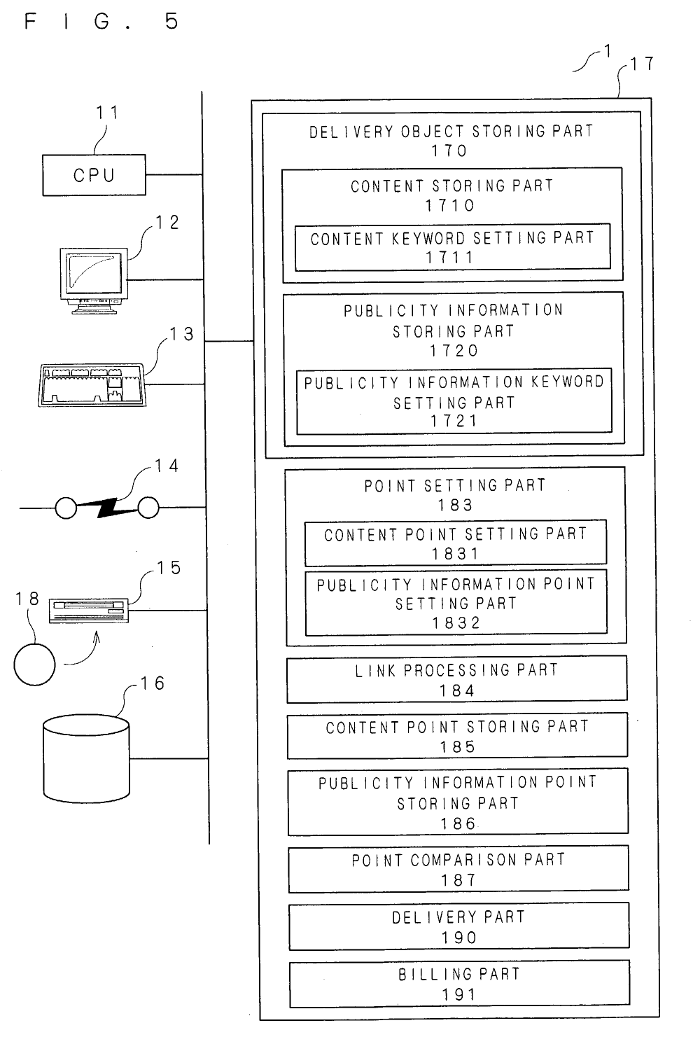

The memory 17 is a work area used in order for the CPU 11 to execute the program stored in the storage part 16. As the result of execution of the program by the CPU 11, the following functions are mainly implemented in the memory 17 for the delivery management of the content: a delivery object storing part 170; an event execution condition setting part 172; a delivery counter 173; an event execution part 174; an acceptance processing part 175; a profit distributing part 176; a delivery part 190; and a billing part 191. Further, though other constituent elements which are not shown, having functions used for the billing process, are implemented through execution of the program by the CPU 11 in the memory 17 at the same time, FIG. 2 omits the constituent elements which are not directly related to the delivery status management, for convenience of illustration. The omitted constituent elements are shown in FIG. 5 and will be described later.

The delivery object storing part 170 stores the content CT provided from the content provider terminal 3 and the publicity information SJ provided from the publicity information provider terminal 4. For this function, the delivery object storing part 170 comprises a content storing part 1710 and a publicity information storing part 1720.

The content storing part 1710 stores the content CT provided from the content provider terminal 3. The content storing part 1710 can store a plurality of contents CT. The content CT stored in the content storing part 1710 is delivered to the user terminal 2 through the network 5 by the later-described delivery part 190 in response to a delivery request from the user terminal 2.

The publicity information storing part 1720 stores the publicity information SJ provided from the publicity information provider terminal 4. The publicity information storing part 1720 can store a plurality of pieces of publicity information SJ. The publicity information SJ stored in the publicity information storing part 1720 is delivered to the user terminal 2 through the network 5 by the later-described delivery part 190 in response to a request from the user terminal 2.

Further, the content storing part 1710 and the publicity information storing part 1720 may be included in the storage part 16.

The event execution condition setting part 172 sets an event execution condition EC. The event execution condition EC is used in execution of various events, relating to the delivery status management, performed with the function of the later-described event execution part 174, and is set in accordance with the delivery objects stored in the delivery object storing part 170. The event execution condition EC is a condition on the number of deliveries which is set for each event. When the event execution condition EC for an event is satisfied as the result of repeating the delivery of the content CT, the event execution part 174 transmits delivery information on the event corresponding to the satisfied event execution condition EC.

The set events include notification of the delivery status of the content CT to the user terminal 2, a new content provision request for requesting the content provider to provide a new content, issuance of profit information which is made when the profit gained by the delivery of the provided content CT is distributed to the content provider, and the like, which are executed for the content provider terminal 3. Further, the set events include billing of the delivery commission to the publicity information provider in delivering the publicity information SJ, and the like, which are executed for the publicity information provider terminal 4. When the number of deliveries of the publicity information SJ satisfies the event execution condition EC, the later-described delivery part 190 stops the delivery of the publicity information SJ.

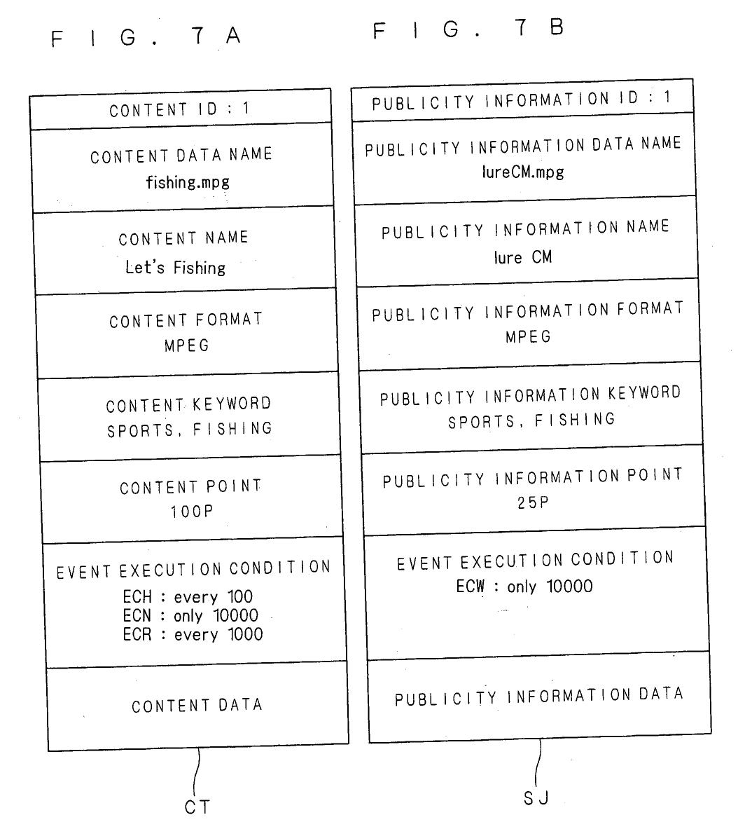

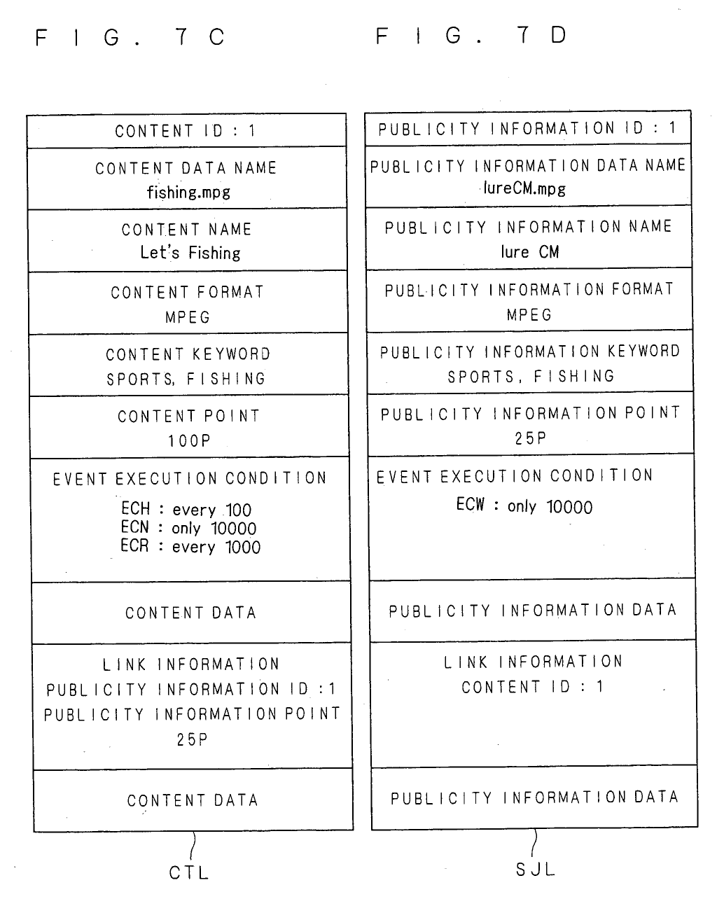

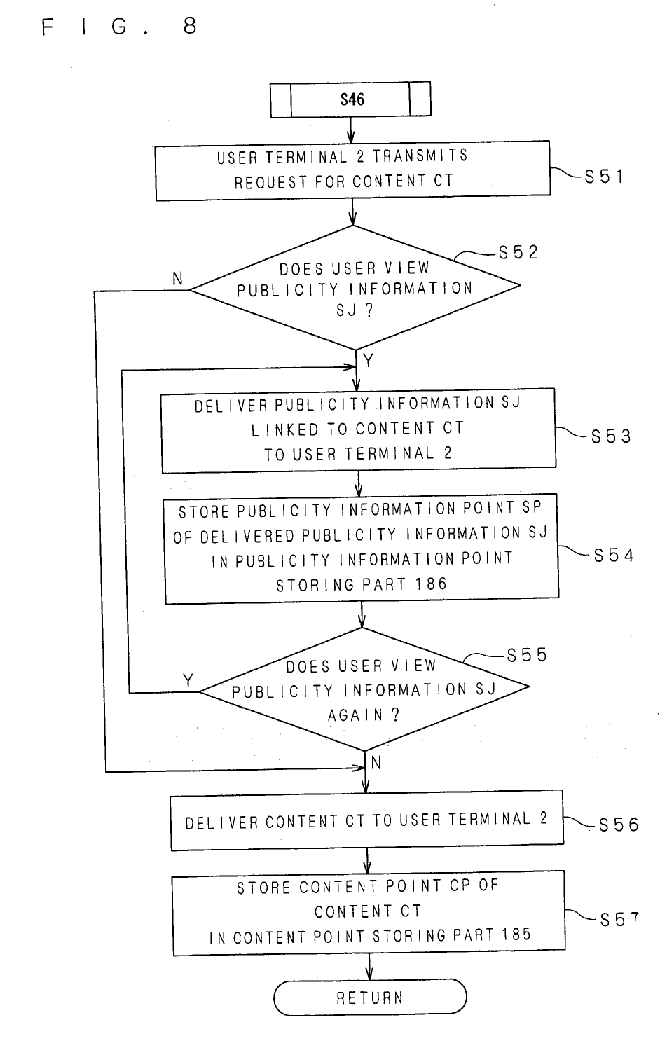

The event execution condition setting part 172 sets a delivery status notification condition ECH, a new request condition ECN, a profit information issuance condition ECR, a delivery commission billing condition ECW and the like as the event execution condition EC. Such conditions are described in a head of the content CT or a head of the publicity information SJ (see FIGS. 7A and 7B).

The delivery counter 173 counts the number of deliveries of the delivery objects by the later-described delivery part 190. For this function, the 173 comprises a content delivery counter 1731 and a publicity information delivery counter 1732.

The content delivery counter 1731 counts the number of the times that the delivery part 190 delivers the content CT. The content delivery counter 1731 is provided for each content CT stored in the content storing part 1710 and can count the number of content deliveries CC on each of a plurality of contents CT.

The publicity information delivery counter 1732 counts the number of the times that the delivery part 190 delivers the publicity information SJ. The publicity information delivery counter 1732 is provided for each publicity information SJ stored in the publicity information storing part 1720 and can count the number of publicity information deliveries SC on each of a plurality of pieces of publicity information SJ.

When the number of deliveries of the delivery objects satisfies any one of the event execution conditions EC, the event execution part 174 executes an event corresponding to the satisfied event execution condition EC. Specifically, the event execution part 174 transmits the delivery information relating to the above event to the content provider terminal 3 or the publicity information provider terminal 4. The delivery information includes delivery status information on the delivery status of the content CT, new content request information for requesting provision of a new content, profit information on profit distribution for the content provider, and the like, which are transmitted to the content provider terminal 3. Further, the delivery information includes delivery commission billing information for billing the delivery commission and the like, which are transmitted to the publicity information provider terminal 4.

In order to generate and transmit such delivery information, the event execution part 174 comprises a delivery status notification part 1741, a new content requesting part 1742, a profit information issuing part 1743 and a delivery commission billing part 1744.

The delivery status notification part 1741 performs a process to notify the content provider terminal 3 of the delivery status of the content CT to the user terminal 2. The status of use of the content CT is essential information in order for the content provider to grasp the popularity of the content CT. Then, when the number of deliveries satisfies any one of the event execution conditions EC as the result repeating the delivery of the content CT, the delivery status notification part 1741 generates the delivery status information including the number of deliveries at that time and transmits the delivery status information to the content provider terminal 3. The content provider can refer to the delivery status information to make a judgment on provision of the content CT in the future.

The new content requesting part 1742 performs a process to request the provision of a new content to the content provider terminal 3. Repeating the delivery of the content CT to the users, the content CT are consumed and a new content CT is needed. Then, the number of deliveries of the content CT satisfies a predetermined event execution condition EC, the new content requesting part 1742 generates the new content request information and transmits the new content request information to the content provider terminal 3. The content provider refers to the new content provision request, to determine whether the new content CT is needed or not.

The profit information issuing part 1743 performs a process to issue the profit information to the content provider terminal 3 when the profit which is gained by the delivery of the content CT is distributed. When the delivery of the content CT to the users is repeated, this produces a profit. When the number of deliveries of the content CT satisfies a predetermined event execution condition EC, the profit information issuing part 1743 generates the profit information on the profit which is distributed to the content provider and transmits the profit information to the content provider terminal 3. The content provider can refer to the profit information to make a judgment on provision of the content CT in the future.

The delivery commission billing part 1744 performs a process to bill the delivery commission which is collected for delivery of the publicity information SJ to the publicity information provider terminal 4. When the publicity information provider consigns the delivery of the publicity information SJ, the delivery commission billing part 1744 generates the delivery commission billing information and transmits the delivery commission billing information to the publicity information provider terminal 4 in order to collect the delivery commission. Further, when the number of deliveries satisfies the event execution condition EC as the result of repeating the delivery of the publicity information SJ, the delivery commission billing part 1744 transmits the delivery commission billing information to the publicity information provider terminal 4 again. When the publicity information provider wants to deliver the publicity information SJ stored in the publicity information storing part 1720 from the server 1 again, the publicity information provider answers the bill of the delivery commission and conducts formalities on payment of the delivery commission on the basis of the function implemented by the later-described acceptance processing part 175.

The acceptance processing part 175 performs a process for acceptance of the delivery commission paid by the publicity information provider. The publicity information provider needs to pay the delivery commission to the ASP which has the server 1 in order to deliver the publicity information SJ to the users. The acceptance processing part 175 processes the information on payment of the delivery commission transmitted from the publicity information provider terminal 4. Further, the acceptance processing part 175 performs the process for acceptance of the delivery commission also when the publicity information provider consigns redelivery of the publicity information SJ to the ASP.

The processing on acceptance of the delivery commission may be executed by a method which allows a direct payment on the internet, such as Web money, or a method of notifying that the delivery commission is transferred into a bank account of the ASP which has the server 1.

The profit distributing part 176 performs a process to distribute the profit which is gained by the delivery of the content CT to the users. The sources of the profit which is gained by the delivery of the content CT is a content fee which is gained when the users directly use the content CT. The profit distributing part 176 performs a process to distribute the profit which is gained by the delivery of the content CT to the ASP which has the server 1 and the content provider.

The delivery part 190 delivers the content CT and the publicity information SJ stored in the content storing part 1710 and the publicity information storing part 1720, respectively, to the user terminal 2. The delivery part 190 delivers the content CT and the publicity information SJ to the user terminal 2 through the network I/F 14 via the network 5 in response to the request for use of the content CT from the user terminal 2.

Further, when the number of deliveries of the publicity information SJ satisfies the event execution condition EC, the delivery part 190 stops the delivery of the publicity information SJ. Since the delivery of the publicity information SJ over the amount corresponding to the collected delivery commission is not performed.

Additionally, when the publicity information provider pays the delivery commission for a redelivery of the publicity information SJ and the acceptance processing part 175 completed the procedure of acceptance, the delivery part 190 resumes the delivery of the publicity information SJ.

The billing part 191 is provided to perform a process of billing for the use of the content CT by the user terminal 2. The user of the content CT needs to pay a content fee determined for each content CT in using the content CT. The billing part 191 performs a process to calculate a billing amount in this case. Further, in the provision of the content CT using the content providing system 100, a discount of the billing amount can be made on condition that the user should view a predetermined publicity information SJ. The billing part 191 performs the calculation of the billing amount also in this case. The details of the billing process will be discussed later.

Delivery of Content CT and Execution of Events

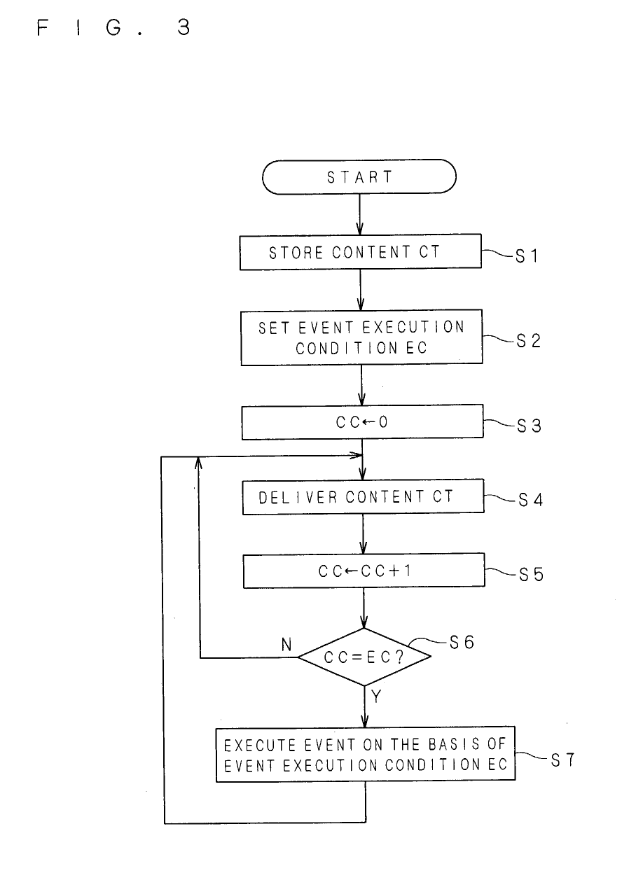

FIG. 3 is a flowchart showing an operation for the delivery of the content CT in the content providing system 100.

In Step S1, the server 1 receives the provision of the content CT from the content provider terminal 3. The content provider transmits the content CT from the content provider terminal 3 to the server 1 through the network 5. The server 1 which receives the content CT stores the content CT into the content storing part 1710.

In Step S2, with the function of the event execution condition setting part 172, the event execution condition EC is set for the content CT stored in the content storing part 1710. An operator of the server 1 manipulates the input part 13 to operate the event execution condition setting part 172, thereby setting the event execution condition EC for each event corresponding to the content CT, such as the delivery status notification condition ECH, the new request condition ECN and the profit information issuance condition ECR.

FIG. 7A is a view showing a constitution of the content CT stored in the content storing part 1710. The content CT includes information on a plurality of items such as “content ID”, “content data name”, “content name”, “content format”, “content keyword”, “content point” and “event execution condition” in its head.

The “content ID” is an item on ID number for identifying the content CT, the “content data name” is an item on a name of data which is provided as the content CT, the “content name” is an item on a name of the content CT, and the “content format” is an item on a data format of the content CT. These items are described in the head at the time when the content CT is provided in principle. Among typical data formats of the content CT are MPEG (Moving Picture Experts Group) format for moving pictures, MP3 (MPEG Audio Layer 3) format for music and the like. Naturally, the data format of the content CT is not limited to the above ones.

The “content keyword” and the “content point” are items on the billing process for the use of the content CT by the user and these items will be discussed later.

The “event execution condition” is an item on the event execution condition EC set for the content CT. Specifically, the delivery status notification condition ECH, the new request condition ECN, the profit information issuance condition ECR and the like, which are above discussed, are described. When the number of deliveries CC of the content CT satisfies any one of the event execution conditions EC in a process later discussed, the event execution part 174 executes an event corresponding to the satisfied event execution condition.

In the content CT of FIG. 7A, the “content ID” is “1”, the “content data name” is “fishing.mpg”, the “content name” is a program name as “Let's fishing”, and the “content format” is “MPEG”.

The set “event execution condition” is that the delivery status notification condition ECH is “every 100”, the new request condition ECN is “only 10000” and the profit information issuance condition ECR is “every 1000”. Specifically, in the process discussed later, the delivery status information is transmitted to the content provider terminal 3 which provides the content CT every time when the number of deliveries of the content CT reaches the multiples of 100, the new content provision request is transmitted when the number of deliveries reaches 10000 and the profit information is transmitted every time when the number of deliveries reaches the multiples of 1000.

In Step S3, the content delivery counter 1731 is reset and the number of content deliveries CC is set to 0. When a plurality of contents CT are stored in the content storing part 1710, all the content delivery counters 1731 which are set for the respective contents CT are reset and a plurality of numbers of content deliveries CC are set to 0.

In Step S4, the server 1 delivers the content CT in response to the request from the user terminal 2. The delivery part 190 reads out the content CT which is desired by the user out from the content storing part 1710 and delivers the content CT to the user terminal 2 through the network I/F 14 via the network 5.

In Step S5, in response to the delivery of the content CT in Step S4, 1 is added to the number of content deliveries CC in the content delivery counter 1731 which is set for the content CT.

In Step S6, the event execution part 174 refers to the number of content deliveries CC of the content delivery counter 1731 and judges whether or not the number of content deliveries CC satisfies the event execution condition EC set for the content CT. When the number of content deliveries CC does not coincide with the event execution condition EC, going back to Step S4, the delivery of the content CT is performed again.

When the number of content deliveries CC satisfies any one of the event execution conditions EC, going to Step S7, the event corresponding to the satisfied event execution condition EC is executed by the event execution part 174.

When the number of content deliveries CC coincides with the delivery status notification condition ECH, the delivery status notification part 1741, referring to the number of content deliveries CC in the content delivery counter 1731 at that time, generates the delivery status information with description that the content CT has been delivered to the user terminal 2 by the number of content deliveries CC and transmits the delivery status information to the content provider terminal 3. The content provider can thereby know the delivery status of the content CT and can refer to the delivery status in creating and providing another content CT.

In the case of the content CT of FIG. 7A, since the delivery status notification condition ECH is “every 100”, the delivery status notification part 1741 transmits the delivery status information of the content CT to the content provider terminal 3 every time when the number of deliveries of the content CT reaches the multiples of 100.

When the number of content deliveries CC satisfies the new request condition ECN, the new content requesting part 1742 generates new content request information and transmits the information to the content provider terminal 3. The content provider can thereby provide a new content at appropriate periods.

In the case of the content CT of FIG. 7A, since the new request condition ECN is “only 10000”, the new content requesting part 1742 generates the new content request information and transmits the information to the content provider terminal 3 only when the number of deliveries of the content CT reaches 10000.

When the number of content deliveries CC satisfies the profit information issuance condition ECR, the profit information issuing part 1743 issues content delivery profit distribution information to the content provider terminal 3. The content provider can thereby receive a profit which is gained as the result of delivery of the content CT to the user at preferable timings.

The profit of the content provider with the content delivery comes from the content fee paid by the user for the use of the content CT and the delivery commission of the publicity information SJ and is calculated in the profit distributing part 176. The content delivery profit can be obtained by calculation of, e.g.,

CC×CP×n (1)

where the content point CP is a value by which a part fee (a fee per one point) is multiplied in setting the billing amount for the use of the content CT as discussed later and n represents a basis for allocation of profit which is an amount determined under a contract between the manager of the server 1 and the content provider.

It is natural that the profit of the content provider with the content delivery may be calculated by a mathematical formula other than the above in the profit distributing part 176.

In the case of the content CT of FIG. 7A, since the profit information issuance condition ECR is “every 1000”, the profit distributing part 176 calculates the profit of the content provider with the delivery of the content CT every time when the number of deliveries of the content CT reaches the multiples of 1000, and the profit information issuing part 1743 generates the profit information including the calculation result and transmits the information to the content provider terminal 3.

When the process of Step S7 is completed, going back to Step S4, the server 1 performs the delivery of the content CT again.

As discussed above, through the operation shown in the flowchart of FIG. 3 performed in the content providing system 100 of FIG. 1, the ASP which has the server 1 can timely execute the events such as the notification of the status of using the content CT, the new content provision request, the issuance of information on the profit with the delivery and the like, without continuous monitoring of the status of using the content CT.

Delivery of Publicity Information SJ and Execution of Events

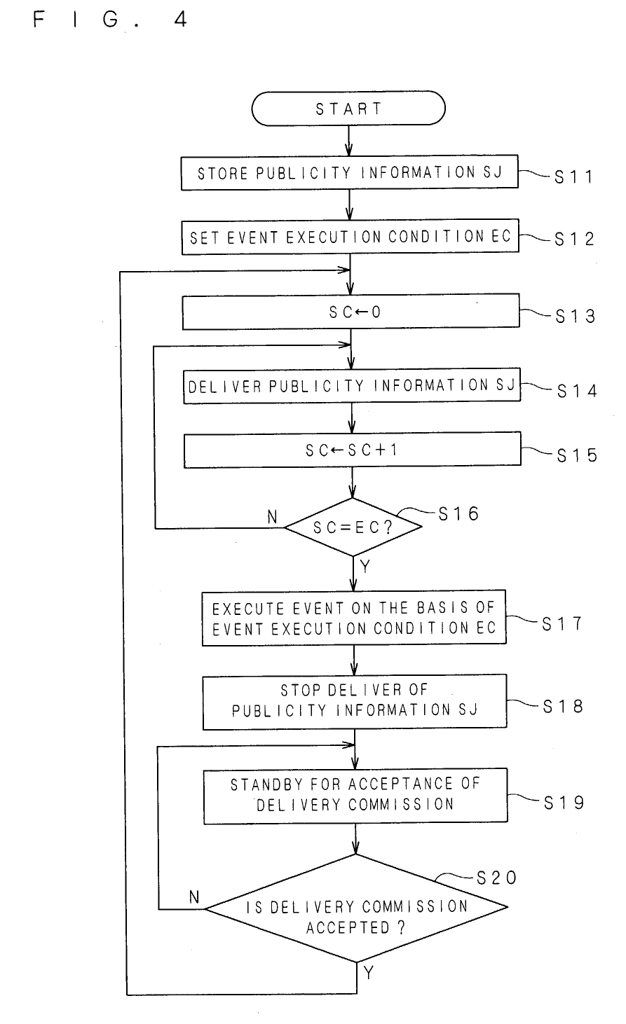

FIG. 4 is a flowchart showing an operation for the delivery of the publicity information SJ in the content providing system 100.

In Step S11, the server 1 receives the provision of the publicity information SJ from the publicity information provider terminal 4. The publicity information provider transmits the publicity information SJ from the publicity information provider terminal 4 to the server 1 through the network 5. The server 1 which receives the publicity information SJ stores the publicity information SJ into the publicity information storing part 1720.

In Step S12, with the function of the event execution condition setting part 172, the event execution condition EC is set for the publicity information SJ stored in the publicity information storing part 1720. The operator of the server 1 manipulates the input part 13 to operate the event execution condition setting part 172, thereby setting the event execution condition EC for each event corresponding to the publicity information SJ, such as the delivery commission billing condition ECW.

FIG. 7B is a view showing a constitution of the publicity information SJ stored in the publicity information storing part 1720. The publicity information SJ includes information on a plurality of items such as “publicity information ID”, “publicity information data name”, “publicity information name”, “publicity information format”, “publicity information keyword”, “publicity information point” and “event execution condition” in its head.

The “publicity information ID” is an item on ID number for identifying the publicity information SJ, the “publicity information data name” is an item on a name of data which is provided as the publicity information SJ, the “publicity information name” is an item on a name of the publicity information SJ, and the “publicity information format” is an item on a data format of the publicity information SJ. These items are described in the head at the time when the publicity information SJ is provided in principle. Among typical data formats of the publicity information SJ are MPEG (Moving Picture Experts Group) format for moving pictures, MP3 (MPEG Audio Layer 3) format for music and the like. Naturally, the data format of the publicity information SJ is not limited to the above ones.

The “publicity information keyword” and the “publicity information point” are items on the billing process for the use of the content CT by the user and these items will be discussed later.

The “event execution condition” is an item on the event execution condition EC set for the publicity information SJ. Specifically, the delivery commission billing condition ECW and the like are described. When the number of deliveries SC of the publicity information SJ satisfies the event execution condition EC in a process later discussed, the event execution part 174 executes an event corresponding to the satisfied event execution condition.

In the publicity information SJ of FIG. 7B, the “publicity information ID” is “1”, the “publicity information data name” is “lureCM.mpg”, the “publicity information name” is a program name as “lure CM”, and the “publicity information format” is “MPEG”.

The set “event execution condition” is that the delivery commission billing condition ECW is “only 10000”. Specifically, in the process discussed later, the delivery commission billing is transmitted to the publicity information provider terminal 4 which provides the publicity information SJ when the number of deliveries of the publicity information SJ reaches 10000.

In Step S13, the publicity information delivery counter 1732 is reset and the number of publicity information deliveries SC is set to 0. When a plurality of pieces of publicity information SJ are stored in the publicity information storing part 1720, all the publicity information counters 1732 which are set for the respective publicity information SJ are reset and a plurality of numbers of publicity information deliveries SC are set to 0.

In Step S14, the server 1 delivers the publicity information SJ in response to the request of the content CT from the user terminal 2. The delivery part 190 reads out the publicity information SJ to be delivered from the publicity information storing part 1720 and delivers the publicity information SJ to the user terminal 2 through the network I/F 14 via the network 5.

In Step S15, in response to the delivery of the publicity information SJ in Step S14, 1 is added to the number of publicity information deliveries SC in the publicity information delivery counter 1732 which is set for the publicity information SJ.

In Step S16, the event execution part 174 refers to the number of publicity information deliveries SC of the publicity information delivery counter 1732 and judges whether or not the number of publicity information deliveries SC satisfies the event execution condition EC set for the publicity information SJ. When the number of publicity information deliveries SC does not coincide with the event execution condition EC, going back to Step S14, the delivery of the publicity information SJ is performed again.

When the number of publicity information deliveries SC satisfies the event execution condition EC set for the publicity information SJ, going to Step S17, the event corresponding to the satisfied event execution condition EC is executed by the event execution part 174.

When the number of publicity information deliveries SC coincides with the delivery commission billing condition ECW, the delivery commission billing part 1744 generates the delivery commission billing information with description that the publicity information SJ has been delivered by a predetermined number and that further delivery commission is needed if the publicity information provider wants continuation of the delivery, and transmits the delivery commission billing information to the publicity information provider terminal 4. The publicity information provider can thereby know that the publicity information SJ has been delivered by the number corresponding to the already-paid delivery commission and select whether to continue the delivery of the publicity information SJ by paying the delivery commission again or to deliver another publicity information SJ which is newly created.

In the case of the publicity information SJ of FIG. 7B, since the delivery commission billing condition ECW is “only 10000”, the delivery commission billing part 1744 generates the delivery commission billing information and transmits the information to the publicity information provider terminal 4 only when the number of deliveries of the publicity information SJ reaches 10000.

In Step S18, the delivery part 190 stops the delivery of the publicity information SJ whose number of deliveries satisfies the delivery commission billing condition ECW. The delivery part 190 refers to the delivery commission billing condition ECW of the publicity information SJ and compares the number of deliveries SC counted in the publicity information delivery counter 1732 with the delivery commission billing condition ECW. As the result of comparison, when the number of deliveries SC satisfies the delivery commission billing condition ECW, the delivery part 190 stops the delivery of the publicity information SJ.

In Step S19, the acceptance processing part 175 is put on standby for a process for acceptance of the delivery commission paid by the publicity information provider. When the publicity information provider wants redelivery of the publicity information SJ whose number of deliveries satisfies the delivery commission billing condition ECW, the publicity information provider needs to further pay the delivery commission to the ASP. Then, the acceptance processing part 175 is put on standby for performing the process for acceptance of the delivery commission from the publicity information provider.

When the delivery commission is paid by the publicity information provider and the process for acceptance is completed in the acceptance processing part 175, going back to Step S13, the delivery part 190 resumes the delivery of the publicity information SJ associated with the paid delivery commission.

As discussed above, through the operation shown in the flowchart of FIG. 4 performed in the publicity information providers 100 of FIG. 1, the ASP which has the server 1 can timely execute the events such as the redelivery and update of the publicity information SJ to the publicity information provider without continuous monitoring of the delivery status of the publicity information SJ.

Though the event execution condition EC is described in the head of the content CT or the publicity information SJ in the foregoing discussion, the event execution condition EC associated with the content CT or the publicity information SJ may be set based on a database in which the information on the event execution condition are collected.

Further, though the foregoing discussion has been made on the case where one user terminal 2, one content provider terminal 3 and one publicity information provider terminal 4 are connected to the network 5, a plurality of user terminals 2, a plurality of content provider terminals 3 and a plurality of publicity information provider terminals 4 may be connected to the network 5.

Furthermore, the stop of delivery of the publicity information SJ and the acceptance of the delivery commission in Steps S18 to S20 may be performed as follows.

When the number of deliveries SC of the publicity information SJ satisfies the delivery commission billing condition ECW, the delivery commission billing part 1744 issues the delivery commission billing information to the publicity information provider terminal 4 of the publicity information provider. The acceptance processing part 175 is put on standby for a given period of time for performing the process for acceptance of the delivery commission from the publicity information provider. If the delivery commission is not paid by the publicity information provider during the standby of the acceptance processing part 175, the delivery part 190 stops the delivery of the publicity information SJ.

In the above procedure, since the delivery of the publicity information SJ is not stopped immediately even when the number of deliveries SC of the publicity information SJ satisfies the delivery commission billing condition ECW, the publicity information provider can consider whether to continue or stop the delivery of the publicity information SJ and it is therefore possible to provide a convenient service for the publicity information provider.

Further, there may be a case where the delivery part 190 resumes the delivery of the publicity information SJ when the delivery commission is paid by the publicity information provider after the standby and the acceptance processing part 175 performs the predetermined process.

In the above procedure, since the publicity information SJ which is once stopped delivering can be delivered again, it is possible to provide more convenient service for the publicity information provider.

Alternatively, if the publicity information provider pays the delivery commission before the number of publicity information deliveries SC satisfies the delivery commission billing condition ECW, when the number of deliveries SC of the publicity information SJ satisfies the delivery commission billing condition ECW, the delivery part 190 may continue the delivery of the publicity information SJ without stopping.

In this case, since the stop of the delivery of the publicity information SJ is prevented by prepaying the delivery commission for the publicity information SJ before the number of publicity information deliveries SC satisfies the delivery commission billing condition ECW, it is possible to provide more convenient service for the publicity information provider.

Billing Process

Next discussion will be made on a billing process performed in the content providing system 100 of the present invention.

In the content providing system 100 of the present invention, when the user terminal 2 uses the content CT which is delivered by the server 1, the server 1 stores a content point CP (discussed later) which is set for the content CT in advance for each user and bills the user which uses the content CT through the user terminal 2 for the content fee on the basis of the content point CP. On the other hand, when the user views the publicity information SJ linked to the content CT in using the content CT, the server 1 stores a publicity information point SP which is set for the publicity information SJ in advance for each user and discounts the content fee by reducing the content point CP by the stored publicity information point SP.

FIG. 5 is a view showing a constitution of the server 1, particularly, constituent elements in the memory 17 to perform the billing process. The constituent elements other than the memory 17 are the same as those of FIG. 2 and not described herein. In the memory 17, functions of the delivery object storing part 170, a point setting part 183, a link processing part 184, a content point storing part 185, a publicity information point storing part 186, a point comparison part 187, the delivery part 190 and the billing part 191 are implemented to perform the billing process. As mentioned above, though other constituent elements in the memory 17 are implemented through execution of the program by the CPU 11, the constituent elements relating to the billing process are preferentially shown in FIG. 5, for convenience of illustration.

As discussed above, the delivery object storing part 170 comprises the content storing part 1710 and the publicity information storing part 1720, and the content storing part 1710 comprises a content keyword setting part 1711 for performing a process to set a content keyword for the stored content CT. With the function of the content keyword setting part 1711, it is realized that the operator of the server 1 sets the content keyword appropriate to the details of the content CT. The publicity information storing part 1720 comprises a publicity information keyword setting part 1721 for performing a process to set a publicity information keyword for the stored publicity information SJ. With the function of the publicity information keyword setting part 1721, it is realized that the operator of the server 1 sets the publicity information keyword appropriate to the details of the publicity information SJ.

The point setting part 183 performs a process to set the content point CP for the content CT stored in the content storing part 1710 and the publicity information point SP for the publicity information SJ stored in the publicity information storing part 1720. For performing this process, the point setting part 183 comprises a content point setting part 1831 and a publicity information point setting part 1832.

The content point setting part 1831 is provided to set the content point CP for the content CT. The content point CP is a value which is referred to when the billing is performed for the use of the content CT. With the function of the content point setting part 1831, it is implemented to set a fee m per one point of the content point CP and the content point CP corresponding to the billing amount in accordance with the use of the content CT. When a plurality of contents CT are stored in the content storing part 1710, with the function of the content point setting part 1831, the content point CP is set for each of the contents CT.

The publicity information point setting part 1832 is provided to set the publicity information point SP for the publicity information SJ. The publicity information point SP is a value which is used to discount the billing amount for the use of the content CT. With the function of the publicity information point setting part 1832, the publicity information point SP for the publicity information SJ is so set as to be appropriate to a discount amount. When a plurality of pieces of publicity information SJ are stored in the publicity information storing part 1720, with the function of the publicity information point setting part 1832, the publicity information point SP is set for each of a plurality of pieces of publicity information SJ.

Further, in the publicity information point setting part 1832, the value of the publicity information point SP for the publicity information SJ can be individually set for each content CT. Specifically, when the publicity information SJ is linked to a plurality of contents CT, by the link processing part 184 discussed later, different publicity information points SP can be set correspondingly to the respective contents CT to which the publicity information SJ is linked in the publicity information point setting part 1832.

The link processing part 184 links the publicity information SJ stored in the publicity information storing part 1720 to the content CT stored in the content storing part 1710. When the publicity information SJ is linked to the content CT, even if a plurality publicity information SJ are stored in the publicity information storing part 1720, only the publicity information SJ which is relevant to the details of the content CT is linked thereto in the link processing part 184. Further, in the link processing part 184, a plurality of pieces of publicity information SJ which are relevant to the details of the content CT can be also linked to the content CT. Furthermore, the link processing part 184 can establish a link between a plurality of contents CT and a plurality of pieces of publicity information SJ which are relevant to the respective details of the contents CT.

When the content CT is used by the user terminal 2, the content point storing part 185 stores the content point CP set for the content CT for each user. Specifically, the content point storing part 185 refers to an IP address, a MAC address, a user ID and the like of the user terminal 2, to store the content point CP for each user.

When the publicity information SJ is viewed by the user terminal 2, the publicity information point storing part 186 stores the publicity information point SP for the publicity information SJ for each user. Specifically, the publicity information point storing part 186 refers to the IP address, the MAC address, the user ID and the like of the user terminal 2, to store the publicity information point SP for each user.

Further, when a plurality of pieces of publicity information SJ are viewed by the user terminal 2, the publicity information point storing part 186 stacks the publicity information points SP of a plurality of pieces of publicity information SJ that are viewed for each user and stores the stacked publicity information point SP therein.

The point comparison part 187 compares the content point CP with the publicity information point SP for calculating the billing amount for the use of the content CT by the user. As the result of comparison between the content point CP and the publicity information point SP, the billing amount for the content CT is reduced in the billing part 191 in accordance with the difference. Specifically, when the following expression is true,

CP≦SP (2)

the user do not have to pay the fee for the use of the content CT.

Further, also when a plurality of pieces of publicity information SJ are viewed by the user, the point comparison part 187 compares the stacked publicity information point SP which is stored in the publicity information point storing part 186 with the content point CP and the billing amount for the content CT is reduced by the difference in the billing part 191 discussed later.

The delivery part 190 delivers the content CT and the publicity information SJ linked to the content CT to the user terminal 2. The delivery part 190 delivers the content CT that is desired by the user to the user terminal 2 via the network 5. In this case, when the user desires to view the publicity information SJ, the delivery part 190 delivers the publicity information SJ linked to the content CT that is desired by the user.

In order to avoid a wrongful use of the content CT, e.g., when the user can not pay the required fee for the use of the content CT, the delivery part 190 stops the delivery of the content CT when the result of comparison between the content point CP and the publicity information point SP which is performed by the point comparison part 187 is

CP>SP (3)

The billing part 191 is provided to perform a billing process for use of the content CT by the user terminal 2. As discussed earlier, since the fee m per one point of the content point CP is set by the content point setting part 1831, the billing part 191 calculates

CP×m (4)

to obtain the billing amount for the user.

With the result of comparison between the content point CP and the publicity information point SP which is performed by the point comparison part 187, the billing part 191 discounts the billing amount for the user. When the content CT and the publicity information SJ linked to the content CT are delivered to the user terminal 2, the billing amount for the user is discounted by calculating

(CP−SP)×m (5)

Specifically, when the following expression is true,

CP≦SP (6)

the billing part 191 does not bill the user.

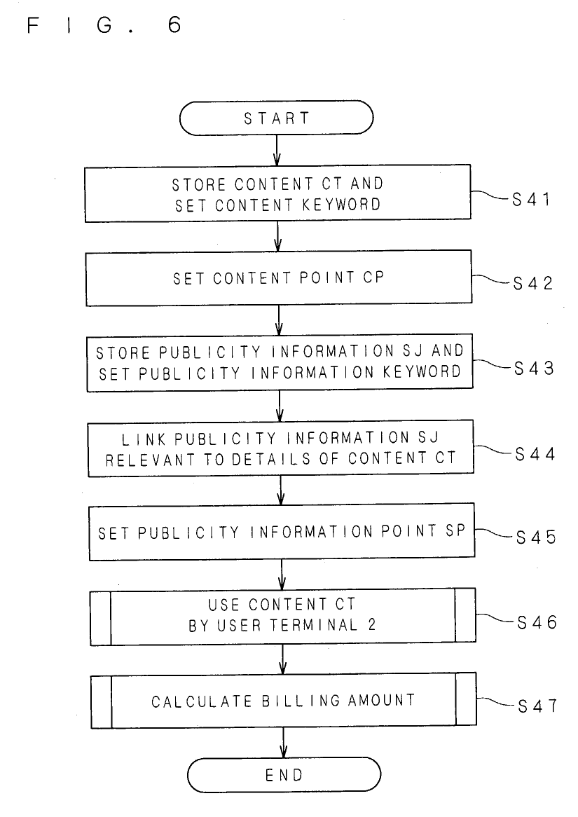

FIG. 6 is a flowchart showing an overall operation on the use of content providing system 100 and the billing.

In Step S41, the server 1 is provided with the content CT from the content provider terminal 3. The content provider terminal 3 transmits the content CT to the server 1 via network 5. Receiving the content CT, the server 1 stores the content CT into the content storing part 1710. At this time, with the function of the content keyword setting part 1711, the content keyword for the stored content CT is set. The operator of the server 1 confirms the details of the content CT and manipulates the input part 13 to operate the content keyword setting part 1711, thereby setting the content keyword, correspondingly to the content CT, appropriate to the details of the content CT and describing the content keyword in the head of the content CT.

In Step S42, the content point CP corresponding to the content CT which is stored in the content storing part 1710 is set with the function of the content point setting part 1831. The operator of the server 1 manipulates the input part 13 to operate the content point setting part 1831, thereby setting the content point CP for the content CT. In the content point setting part 1831, the fee m per one point is set and the content point CP which corresponds to the billing amount for the use of the content CT is set for each content CT. When a plurality of contents CT are stored in the content storing part 1710, in the content point setting part 1831, the content point CP is set for each of the contents CT.

The order of Steps S41 and S42 may be reversed.

In Step S43, the server 1 is provided with the publicity information SJ from the publicity information provider. The publicity information provider transmits the publicity information SJ to the server 1 via network 5. Receiving the publicity information SJ, the server 1 stores the publicity information SJ into the publicity information storing part 1720. At this time, with the function of the publicity information keyword setting part 1721, the publicity information keyword for the stored publicity information SJ is set. The operator of the server 1 confirms the details of the publicity information SJ and manipulates the input part 13 to operate the publicity information keyword setting part 1721, thereby setting the publicity information keyword, correspondingly to the publicity information SJ, appropriate to the details of the publicity information SJ and describing the publicity information keyword in the head of the publicity information SJ.

In Step S44, the link processing part 184 links the publicity information SJ to the content CT. The link processing part 184 acquires the content CT from the content storing part 1710 and acquires the publicity information SJ associated with the details of the content CT from the publicity information storing part 1720, and provides the content CT and the publicity information SJ which are acquired with link information to establish a link between the content CT and the publicity information SJ. Alternatively, the link processing part 184 acquires the publicity information SJ from the publicity information storing part 1720 and acquires the content CT associated with the details of the publicity information SJ from the content storing part 1710, and provides the content CT and the publicity information SJ which are acquired with link information to establish the link between the content CT and the publicity information SJ.

In Step S45, with the function of the publicity information point setting part 1832, the publicity information point SP corresponding to the publicity information SJ stored in the publicity information storing part 1720 is set. On the basis of the function of the publicity information point setting part 1832, the operator of the server 1 manipulates the input part 13 to set the publicity information point SP. In the publicity information point setting part 1832, the publicity information point SP which corresponds to the discount from the billing amount for the use of the content CT is set for each publicity information SJ. When a plurality of pieces of publicity information SJ are stored in the publicity information storing part 1720, in the publicity information point setting part 1832, the publicity information point SP is set for each of a plurality of pieces of the publicity information SJ.

The content point CP and the publicity information point SP may be set by the content provider and the publicity information provider, respectively, in advance.

FIGS. 7A to 7D are views showing constitutions of content CT (CTL) and publicity information SJ (SJL) before and after providing the link information.

FIG. 7A is a view, as discussed earlier, showing the constitution of the content CT stored in the content storing part 1710. The content CT includes information on a plurality of items such as “content ID”, “content data name”, “content name”, “content format”, “content keyword”, “content point” and “event execution condition” in its head. These items other than “content keyword” and “content point” have been described and discussion on these items are omitted herein.

As the “content keyword”, the content keyword set by the content keyword setting part 1711 in Step S41, i.e., a word representing the details of the content CT is described. It is desirable that a plurality of words should be set as the content keyword. In establishing the link between the content CT and the publicity information SJ with the function of the link processing part 184, the content keyword is referred to.

The “content point” is the content point CP set by the content point setting part 1831 in Step S42. As discussed earlier, the content point is used for calculation of the billing amount for the use of the content CT.

In the content CT of FIG. 7A, since “sports” and “fishing” are set as the “content keyword”, it is possible to confirm that the details of the content CT relates to “fishing”. Further, since “100p” is described in the “content point” , the content point CP set for the content CT takes 100 points.

FIG. 7B is a view, as discussed earlier, showing the constitution of the publicity information SJ stored in the publicity information storing part 1720. The publicity information SJ includes information on a plurality of items such as “publicity information ID”, “publicity information data name”, “publicity information name”, “publicity information format”, “publicity information keyword”, “publicity information point” and “event execution condition” in its head. These items other than “publicity information keyword” and “publicity information point” have been described and discussion on these items are omitted herein.

As the “publicity information keyword”, the publicity information keyword set by the publicity information keyword setting part 1721 in Step S43, i.e., a word representing the details of the publicity information SJ is described. It is desirable that a plurality of words should be set as the publicity information keyword. In establishing the link between the content CT and the publicity information SJ with the function of the link processing part 184, the publicity information keyword is referred to.

The “publicity information point” is the publicity information point SP set by the publicity information point setting part 1832 in Step S45. As discussed earlier, the publicity information point is used for discount of the billing amount for the use of the content CT.

In the publicity information SJ of FIG. 7B, since “sports” and “fishing” are set as the “publicity information keyword”, it is possible to confirm that the details of the publicity information SJ relates to “fishing”. Further, since “25p” is described in the “publicity information point”, the publicity information point SP set for the publicity information SJ takes 25 points.

FIGS. 7C and 7D are views showing constitutions of content CT (CTL) and publicity information SJ (SJL) after establishing the link by the link processing part 184. As discussed above, the information representing the details of the content CT is described in the item of “content keyword” in the head of the content CT. On the other hand, the information representing the details of the publicity information SJ is described in the item of “publicity information keyword” in the head of the publicity information SJ. The link processing part 184 acquires the content CT from the content storing part 1710 and refers to the description of the “content keyword” included in the acquired content CT. Next, the link processing part 184 acquires the publicity information SJ from the publicity information storing part 1720 and, referring to the description of the “publicity information keyword”, judges whether or not there is the same keyword in the “content keyword” and the “publicity information keyword”. When the same keyword is found in both the “content keyword” and the “publicity information keyword”, the link processing part 184 provides the link information to the respective heads of the content CT and the publicity information SJ in order to establish the link between the content CT and the publicity information SJ.

In the content CTL, the publicity information ID and the publicity information point which are described in the head of the publicity information SJ linked thereto are described as the link information. Since the content CT can be linked to a plurality of pieces of publicity information SJ, a plurality of pieces of publicity information IDs and publicity information points can be described as the link information in the head of the content CTL.

In the publicity information SJL, the content ID and the content point which are described in the head of the content CT linked thereto are described as the link information. Since the publicity information SJ can be linked to a plurality of contents CT, a plurality of content IDs can be described as the link information in the head of the publicity information SJL.

When the publicity information keywords of a plurality of pieces of publicity information SJ coincide with the content keyword of the content CT, a plurality of pieces of publicity information SJ are linked to the content CT.

When the content keywords of a plurality of contents CT coincide with the publicity information keyword of the publicity information SJ, the publicity information SJ is linked to each of a plurality of contents CT. When a plurality of pieces of publicity information SJ are present for a plurality of contents CT and the content keywords of the contents CT and the publicity information keywords of the publicity information SJ coincide, a plurality of pieces of publicity information SJ are linked to each of the contents CT.

Further, there may be a case where the operator of the server 1 manipulates the input part 13 to set the link between the content CT and the publicity information SJ.

In Step S46, the server 1 delivers the content CT and the publicity information SJ linked to the content CT to the user terminal 2 and the user terminal 2 views the publicity information SJ and uses the content CT.

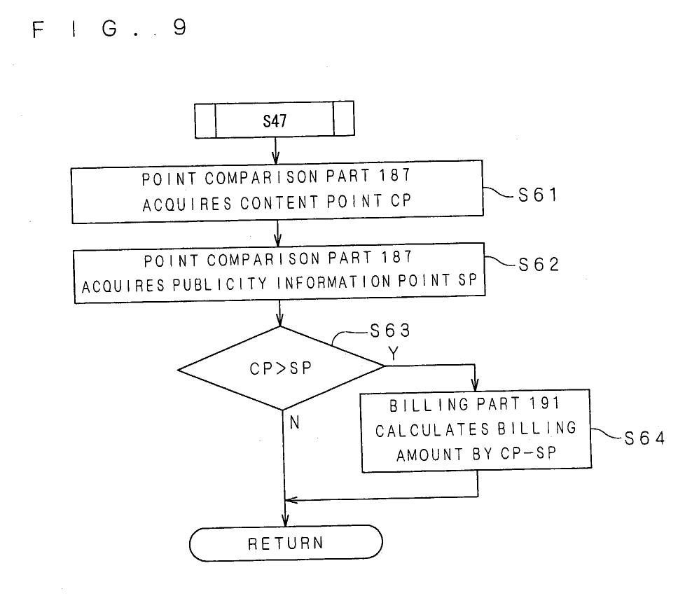

FIG. 8 is a flowchart showing a detailed process of Step S46.

In Step S51, the user terminal 2 transmits the request for the content CT to the server 1. The operator of the user terminal 2 manipulates an input part which is not shown to issue the request of the content CT to the server 1. The user terminal 2 transmits the request of the content CT to the server 1 via the network 5.

In Step S52, the user decides whether he or she should view the publicity information SJ in order to reduce the billing amount for the use of the content CT or not. When the user decides not to view the publicity information SJ, the process goes to Step S56. When the user decides to view the publicity information SJ, the process goes to the nest Step S53.

In Step S53, the delivery part 190 receives the request from the user and delivers the publicity information SJ to the user terminal 2. At this time, the delivery part 190 delivers the publicity information SJ linked to the content CT which is desired by the user in Step S51. The delivery part 190 retrieves the link information on the publicity information SJ which is described in the content CT which is desired by the user and acquires the publicity information SJ which corresponds to the publicity information ID which is described as the link information from the publicity information storing part 1720. The acquired publicity information SJ is delivered to the user terminal 2 through the network I/F 14 via network 5.

When a plurality of pieces of publicity information SJ are linked to the content CT, the user selects and views one of the plurality of pieces of publicity information SJ.

In Step S54, the publicity information point storing part 186 stores the publicity information point SP set for the publicity information SJ which is delivered to the user terminal 2 in Step S53. The publicity information point storing part 186 retrieves the publicity information point SP set for the delivered publicity information SJ in Step S44 and stores the retrieved publicity information point SP. Further, the publicity information point storing part 186 performs management with the MAC address, the IP address and the user ID of the user terminal 2, to store the publicity information point SP for each user terminal 2.

In Step S55, the user decides whether he should subsequently view another publicity information SJ or not. When the user decides to subsequently view another publicity information SJ, going back Step S53, the foregoing process is executed again. When the foregoing process is executed again, the publicity information point SP is stacked and stored in the publicity information point storing part 186. When there is no other publicity information SJ to be viewed or the user decides not to view any more publicity information SJ, the process goes to Step S56.

When the user views the publicity information SJ, he may view the same publicity information SJ repeatedly. Also in this case, the publicity information point SP is stacked and stored in the publicity information point storing part 186.

In Step S56, the delivery part 190 delivers the content CT which is desired by the user. The delivery part 190 acquires the content CT which is desired by the user from the content storing part 1710 and delivers the content CT to the user terminal 2 through the network I/F 14 via the network 5. The user terminal 2 executes the content CT.

In Step S57, in response to the use of the content CT by the user terminal 2, the content point storing part 185 stores the content point CP set for the content CT. The content point storing part 185 retrieves the content point CP set in Step S42 for the content CT which is delivered to the user terminal 2 and stores the retrieved content point CP therein. Further, the content point storing part 185 performs management with the MAC address, the IP address and the user ID of the user terminal 2, to store the content point CP for each user terminal 2.

Back to the flowchart of FIG. 6, in Step S47, the billing part 191 of the server 1 calculates the billing amount for the use of the content CT on the basis of the stored content point CP.

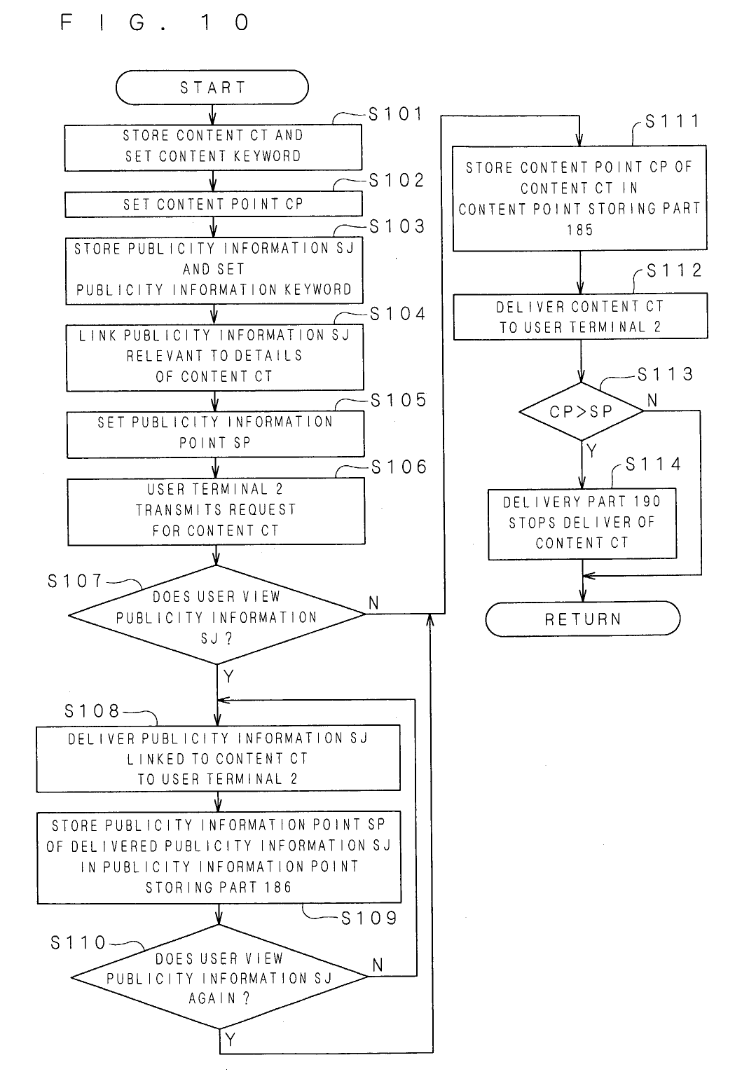

FIG. 9 is a flowchart showing a detailed process of calculating the billing amount which is performed in Step S47.

In Step S61, the content point CP stored in the content point storing part 185 in Step S57 is acquired by the point comparison part 187.

In Step S62, the publicity information point SP stored in the publicity information point storing part 186 in Step S54 is acquired by the point comparison part 187. When a plurality of pieces of publicity information SJ are viewed through the user terminal 2, a plurality of publicity information points SP stored in the publicity information point storing part 186 are acquired.

In Step S63, the point comparison part 187 compares the content point CP with the publicity information point SP.

Further, when the point comparison part 187 acquires a plurality of publicity information points SP from the publicity information point storing part 186, the total of the publicity information points SP is compared with the content point CP. As the result of the comparison between the content point CP and the publicity information point SP by the point comparison part 187, when the following expression is true,

CP>SP (7)

the process goes to Step S64.

In Step S64, the billing part 191 calculates the billing amount on the basis of the content point CP acquired by the point comparison part 187. Since the fee m per one point of the content point CP is set for the content CT, the billing part 191 calculates

CP×m (8)

to obtain the billing amount for the use of the content CT.

At this time, when the user views the publicity information SJ, the billing part 191 calculates

(CP−SP (or total of SPs))×m (9)

to obtain the billing amount with discount by the amount which corresponds to the view of the publicity information SJ.

As the result of comparison between the content point CP and the publicity information point SP by the point comparison part 187 in Step S63, when the following expression is true,

CP≦SP (10)

the billing part 191 does not calculate the billing amount since the content CT is available free of charge.

When the publicity information SJ is viewed in the use of the content CT, as discussed earlier, the billing amount for the use of the content CT is reduced. Moreover, since the publicity information SJ to be viewed is relevant to the details of the content CT, the user does not view an advertisement completely irrelevant to the content CT and therefore does not have any serious complaint. Further, since the publicity information SJ is relevant to the content CT, it arouses an interest of the user in the publicity information SJ and therefore a great effectiveness of advertisement can be expected.

Thus, through the operation shown in the flowchart of FIG. 6 performed by the content providing system 100 of FIG. 1, the user can use the content CT at a cost lower than a predetermined fee by viewing the publicity information SJ relevant to the details of the content CT in using the content.

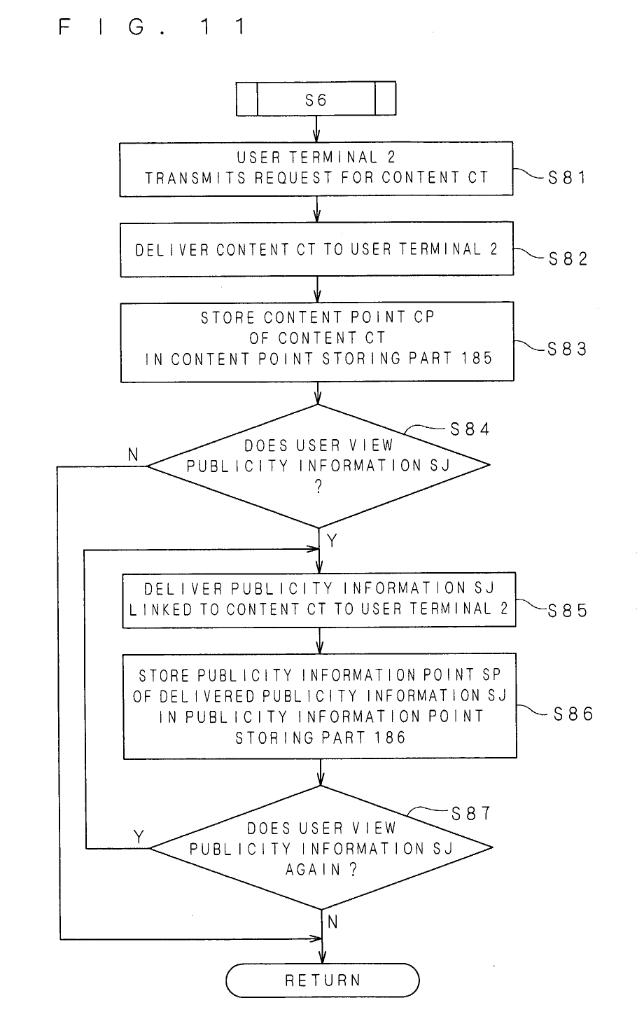

Further, the content providing system 100 may be operated through the flowchart shown in FIG. 10.

FIG. 10 is a flowchart showing another operation of the content providing system 100. Steps S101 to S110 are the same process as shown in the flowchart of FIG. 8 and not discussed.

In Step S111, the content point CP for the content CT which is desired by the user is stored in the content point storing part 185. Then, in Step S112, the delivery part 190 starts delivering the content CT to the user terminal 2 via the network 5. During the delivery of the content CT, the server 1 executes the process of Step S113. Specifically, the point comparison part 187 compares the content point CP stored in the content point storing part 185 with the publicity information point SP stored in the publicity information point storing part 186, and as a result, when the following expression is true,

CP≦SP (11)

the delivery part 190 continues to deliver the content CT.

As the result of comparison by the point comparison part 187, when the following expression is true,

CP>SP (12)

the delivery part 190 stops the delivery of the content CT to the user terminal 2 (Step S114).

Specifically, in the content providing system 100 which performs the operation shown in the flowchart of FIG. 10, if the user intends to use the content CT without viewing a sufficient number of publicity information SJ, the delivery of the content CT is intercepted and it is therefore possible to prevent a wrongful use of the content CT by the user and sufficiently expect the user to view the publicity information SJ.

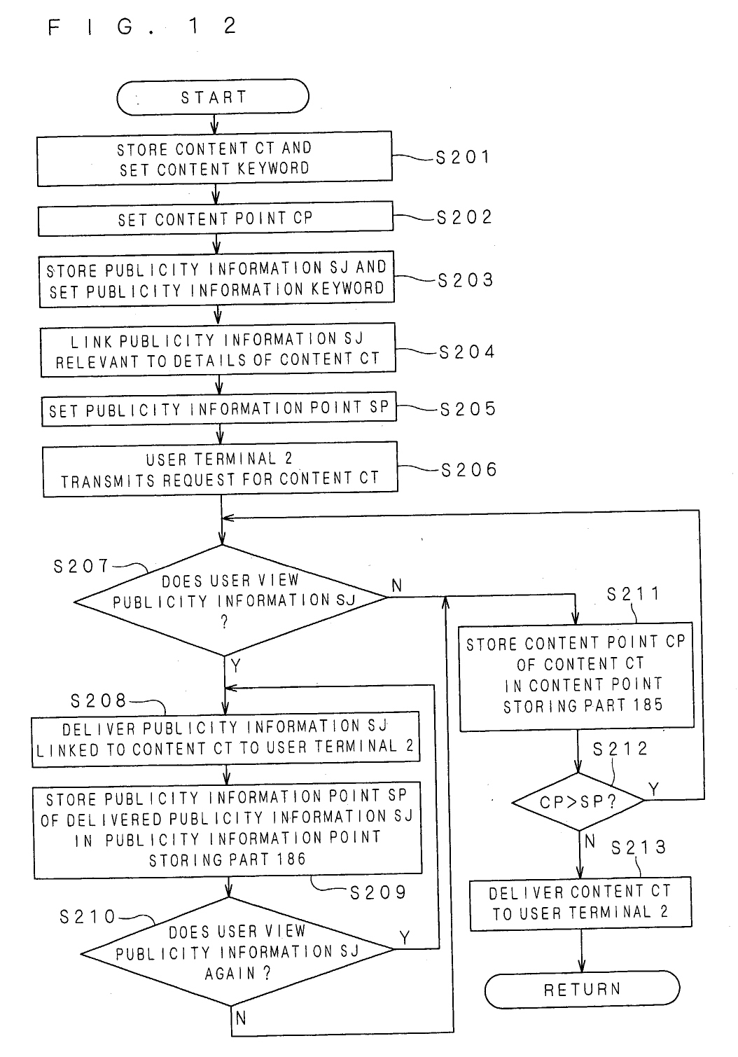

The order of the use of the content CT and the view of the publicity information SJ may be reversed in the flowchart of FIG. 8. Specifically, as shown in the flowchart of FIG. 11, there may be a case where the calculation for billing in Step S46 can be performed even when the user views the publicity information SJ after the use of the content CT.

In the above procedure, since the user views the publicity information SJ under the influence of the content CT, a greater effectiveness of advertisement by the publicity information SJ can be expected.

Instead of the flowchart of FIG. 10, the process shown in the flowchart of FIG. 12 may be performed. In the flowchart of FIG. 12, Steps S201 to S211 are the same as Steps S101 to S111 and not discussed. As shown in FIG. 12, the point comparison part 187 compares the content point CP with the publicity information point SP before the delivery part 190 delivers the content CT and when CP>SP, the delivery part 190 does not deliver the content CT (Steps S212 and S213).

In the above procedure, it is possible to further prevent a wrongful use of the content CT by the user.

As to the link between the content CT and the publicity information SJ, though the link information is stored in the respective heads of the content CT and the publicity information SJ in the foregoing discussion, the link between the content CT and the publicity information SJ may be established by using a database in which the information on the link are collected.

In the case of using a plurality of contents CT, the content point CP is stacked and the publicity information SJ is stacked. The present invention also applies to this case by obtaining the difference between the stacked content points CP and stacked pieces of publicity information SJ.

While the invention has been shown and described in detail, the foregoing description is in all aspects illustrative and not restrictive. It is therefore understood that numerous modifications and variations can be devised without departing from the scope of the invention.

What is claimed is:

1. A digital content providing system comprising:
a) a server for delivering a digital content through a network;
b) at least one terminal for receiving said digital content for a user;
c) at least one content providing element which is a provider of at least one digital content for said server; and
d) at least one publicity information providing element which is a provider of at least one publicity information for said server,
wherein at least one of said at least one publicity information is delivered together when said digital content is delivered from said server, and
said server comprises
a-1) an event execution element for executing an event when a predetermined event execution condition corresponding to said event is satisfied;
a-2) an event execution condition setting element for setting said event execution condition on the number of deliveries of said digital content or said publicity information; and
a-3) a counting element for counting said number of deliveries.

2. The digital content providing system according to claim 1, wherein
said event includes at least one of the following first to fourth events:
a first event of issuing a delivery status notification on a digital content provided by said content providing element to said content providing element;
a second event of issuing a new content provision request to said content providing element;
a third event of notifying said content providing element of information on a profit which is gained by a delivery of said digital content provided by said content providing element; and
a fourth event of issuing a request on a redelivery of said publicity information to said publicity information providing element, and
said event execution condition is set for each of said first to fourth events.

3. A digital content providing system comprising:
a) a server for delivering a digital content through a network;
b) at least one terminal for receiving said digital content for a user;
c) at least one content providing element which is a provider of at least one digital content for said server; and
d) at least one publicity information providing element which is a provider of at least one publicity information for said server,
wherein at least one of said at least one publicity information is delivered together when said digital content is delivered from said server, and
said server comprises
a-1) a point setting element for setting a content point which is given in accordance with use of said digital content and a publicity information point which is given in accordance with view of said publicity information; and
a-2) a point storing element in which said content point which is set is stacked every time when said user uses said digital content and said publicity information point which is set is stacked every time when said user views said publicity information; and
a-3) a billing element for calculating a billing amount for use of said digital content, said billing amount being calculated on the basis of the total value of said content point, the total value of said publicity information point and a part amount which is set per one point of said content point.

4. The digital content providing system according to claim 3, wherein
said server further comprises
a-4) a keyword setting element for setting a content keyword based on details of said digital content and a publicity information keyword based on details of said publicity information; and
a-5) a link element for establishing a link between said digital content and said publicity information on the basis of said content keyword and said publicity information keyword.

5. A server of a digital content providing system which delivers at least one publicity information together while delivering a digital content through a network, comprising:
a) an event execution element for executing an event when a predetermined event execution condition corresponding to said event is satisfied;
b) an event execution condition setting element for setting said event execution condition on the number of deliveries of said digital content or said publicity information; and
c) a counting element for counting said number of deliveries.

6. The server according to claim 5, wherein
said event includes at least one of the following first to fourth events:
a first event of issuing a delivery status notification on a digital content provided by said content providing element to said content providing element;
a second event of issuing a new content provision request to said content providing element;
a third event of notifying said content providing element of information on a profit which is gained by a delivery of said digital content provided by said content providing element; and
a fourth event of issuing a request on a redelivery of said publicity information to said publicity information providing element,
said content providing element is a provider of at least one digital content for said user and said publicity information providing element is a provider of at least one publicity information for said user, and
said event execution condition is set for each of said first to fourth events.

7. The server according to claim 6, wherein
a delivery of said publicity information is stopped with issuance of said request in execution of said fourth event.

8. The server according to claim 7, wherein
said delivery of said publicity information is resumed in response to completion of a required procedure for said redelivery of said publicity information.

9. A server of a digital content providing system which delivers at least one publicity information together while delivering a digital content through a network, comprising:
a) a point setting element for setting a content point which is given in accordance with use of said digital content and a publicity information point which is given in accordance with view of said publicity information; and
b) a point storing element in which said content point which is set is stacked every time when said user uses said digital content and said publicity information point which is set is stacked every time when said user views said publicity information; and
c) a billing element for calculating a billing amount for use of said digital content, said billing amount being calculated on the basis of the total value of said content point, the total value of said publicity information point and a part amount which is set per one point of said content point.

10. The server according to claim 9, further comprising:
d) a keyword setting element for setting a content keyword based on details of said digital content and a publicity information keyword based on details of said publicity information; and
e) a link element for establishing a link between said digital content and said publicity information on the basis of said content keyword and said publicity information keyword.

11. The server according to claim 10, wherein
said billing amount is set in accordance with the number of views of said publicity information.

12. The server according to claim 11, wherein
said billing amount is obtained by multiplying the difference between said total value of said content point and said total value of publicity information point by said part amount.

13. The server according to claim 10, wherein
said digital content is available when said total value of said publicity information point is larger than a predetermined threshold point value.

14. The server according to claim 13, wherein
a delivery of said digital content is stopped when said total value of said publicity information point is smaller than a predetermined point value.

15. The server according to claim 13, wherein
said delivery of said digital content is started when said total value of said publicity information point exceeds said predetermined point value.

16. A method of delivery management in a digital content providing system,
wherein said digital content providing system comprises
a) a server for delivering a digital content through a network;
b) at least one terminal for receiving said digital content for a user;
c) at least one content providing element which is a provider of at least one digital content for said server; and
d) at least one publicity information providing element which is a provider of at least one publicity information for said server, and
said digital content providing system delivers at least one of said at least one publicity information together while delivering said digital content from said server,
said method comprising the steps of:
d-1) executing an event when a predetermined event execution condition corresponding to said event is satisfied;
d-2) setting said event execution condition on the number of deliveries of said digital content or said publicity information; and
d-3) counting said number of deliveries.

17. A billing method in a digital content providing system,
wherein said digital content providing system comprises
a) a server for delivering a digital content through a network;
b) at least one terminal for receiving said digital content for a user;
c) at least one content providing element which is a provider of at least one digital content for said server; and
d) at least one publicity information providing element which is a provider of at least one publicity information for said server, and
said digital content providing system delivers at least one of said at least one publicity information together while delivering said digital content from said server,
said method comprising the steps of:
e-1) setting a content point which is given in accordance with use of said digital content and a publicity information point which is given in accordance with view of said publicity information; and
e-2) accumulating said content point which is set every time when said user uses said digital content and said publicity information point which is set every time when said user views said publicity information; and
e-3) calculating a billing amount for use of said digital content, said billing amount being calculated on the basis of the total value of said content point, the total value of said publicity information point and a part amount which is set per one point of said content point.

18. The billing method according to claim 17, further comprising the steps of:
e-4) setting a content keyword based on details of said digital content and a publicity information keyword based on details of said publicity information; and
e-5) establishing a link between said digital content and said publicity information on the basis of said content keyword and said publicity information keyword.

19. A program executed by a computer to cause said computer to function as a server of a system for delivering a digital content through a network, said system delivering at least one publicity information together while delivering said digital content and said server, comprising:
a) an event execution element for executing an event when a predetermined event execution condition corresponding to said event is satisfied;
b) an event execution condition setting element for setting said event execution condition on the number of deliveries of said digital content or said publicity information; and
c) a counting element for counting said number of deliveries.

20. A program executed by a computer to cause said computer to function as a server of a system for delivering a digital content through a network, said system delivering at least one publicity information together while delivering said digital content and said server, comprising:
a) a point setting element for setting a content point which is given in accordance with use of said digital content and a publicity information point which is given in accordance with view of said publicity information; and
b) a point storing element in which said content point which is set is stacked every time when said user uses said digital content and said publicity information point which is set is stacked every time when said user views said publicity information;
c) a billing element for calculating a billing amount for use of said digital content, said billing amount being calculated on the basis of the total value of said content point, the total value of said publicity information point and a part amount which is set per one point of said content point;
d) a keyword setting element for setting a content keyword based on details of said digital content and a publicity information keyword based on details of said publicity information; and
e) a link element for establishing a link between said digital content and said publicity information on the basis of said content keyword and said publicity information keyword.
